(19) United States
(12) Patent Application Publication
(10) Pub. No.: US 2007/0092729 A1
(43) Pub. Date: Apr. 26, 2007

(54) Unvulcanized rubber sheet for gasket material and method for manufacturing unvulcanized rubber sheet for gasket material

(75) Inventors: Toshio Kayao, Okayama (JP); Kazuhiro Takahashi, Okayama (JP)

Correspondence Address: BACON & THOMAS, PLLC, 625 SLATERS LANE, FOURTH FLOOR, ALEXANDRIA, VA, 22314, US

(73) Assignee: Uchiyama Manufacturing Corp., Okayama (JP)

(21) Appl. No.: 11/580,108

(22) Filed: Oct. 13, 2006

(30) Foreign Application Priority Data
Oct. 13, 2005 (JP) 2005-298329

(51) Int. Cl. B32B 9/04

(52) U.S. Cl. 428/411.1

(57) ABSTRACT

An unvulcanized rubber sheet for gasket material composed of a sheet like rubber compound material, wherein the rubber compound material comprises a base fiber material comprised of a compressible inorganic fiber except asbestos and a compressible organic fiber, an unvulcanized rubber material or a rubber latex, rubber agent and inorganic filler. A method for manufacturing the sheet comprises the steps of: disposing a metal plate at a feeding portion of a pair of rollers, each of which rotates opposite direction each other and supplying a rubber compound material into a space between one side of the metal plate and one side of the rollers; passing the metal plate together with the rubber compound material as supplied through the rollers by rotating the rollers to form a spread layer of rubber compound material on the metal plate; and peeling the spread layer thus formed out of the metal plate, thereby forming a continuous spread sheet of rubber compound material.

### FIELD OF THE INVENTION

The present invention relates to an unvulcanized rubber sheet for gasket material made of a compressible material for use in a base material of several kinds of gaskets, particularly to an unvulcanized rubber sheet for gasket material which is integrated on the surface of a metal plate or is used by itself and also to a manufacturing method thereof.

### PRIOR ART

A gasket material formed by coating a compressible material layer on the surface of a metal plate has been widely used. An example of such gasket material is disclosed in JP-B-6-84785 in which a gasket material is formed such that a rubber compound layer mainly including a compressible base fiber material and a rubber material is formed on the surface of a metal plate by a vulcanization coating. This gasket material uses a metal plate as a base material, so that it has high strength, a dimensional accuracy in case of punching process with metal molds, and a superior working property for assembling into a sealing member. Further, because it has a layer of a compressible material, an embossing finish is easily executed. Still further, a rubber material does not drift because of carrying ability of base material fiber, and it has superior sealing ability and heat resistance, therefore it has been widely used as a base material of several kinds of gasket.

JP-A-9-11363 discloses a manufacturing method of the above-mentioned gasket material in which a metal plate coated with a heat resistant adhesive is inserted between a pair of rollers rotating in opposite directions, a rubber compound material including the above-mentioned compressible base fiber material is supplied between the metal plate and the roller, the metal plate passes between the rollers, and a rubber compound layer is vulcanized and coated on the surface of the metal plate. Further, JP-B-6-86075 and Japan Patent Number 2573932 disclose a method for obtaining a joint sheet in which a rubber compound material (rubber mixture) including fiber base material is supplied between a cold roller and a heated roller, the rubber compound material is heated and rolled on the surface of the heated roller, and the rolled rubber compound material is peeled off to obtain a joint sheet. In addition, a beater sheet is widely used as a sheet for a gasket material.

The gasket materials disclosed in JP-B-6-84785 and JP-A-9-11363 are widely used for vehicle engines, industrial machinery, mechanical component and the like. The gasket is practically prepared by punching the above-mentioned gasket material in an annular form according to the shape of an objective sealed portion, more particularly in the form including bolt holes. On account of such a shape characteristic of sealed portion, the inner punched-out portion (inside of annular shape) largely occupies the material, the rubber compound layer and the metal plate are joined with an adhesive, and the rubber material is vulcanized, so the inner punched-out portions and other punched-out portions cannot be reused and have little choice but to be discarded. Therefore, the gasket material incurs much waste, thereby causing high product cost.

The joint sheet or the beater sheet disclosed in JP-B-6-86075 and Japan Patent No. 2573932 is prepared separately from the metal plate, so that the punched-out portions of the metal plate can be reused. However, the joint sheet is formed such that the rubber is vulcanized at the time of heat rolling process and the punched-out portions are not reused as mentioned above. When they are reused by being crushed, such problem that its physical property is lowered may cause. Whereas the punched-out portions of the beater sheet can be reused, however, such problem that their fiber densities would become small further their thickness could not be reduced.

### SUMMARY OF THE INVENTION

The present invention is proposed in order to solve the above-mentioned problems and the object of the present invention is to provide an unvulcanized rubber sheet for gasket material and its production method in which the characteristic of gasket material made of a compressible material is utilized to enhance its quality and in which waste materials at the time of production are reduced.

The present invention has the following effects.

When a sheet for gasket material of the present invention is used to be produced as a gasket, a separately prepared metal plate is punched into a predetermined shape, a heat resistant adhesive is applied on both surfaces of the metal- plate, and the gasket material sheet is punched in the same form to be attached on both surfaces of the metal plate by pressurization and compression. A mixture of unclosslinked synthetic resin and graphite is coated on both surfaces thereof according to the prior known method to form a graphite layer when necessary, a heat process is executed at the temperature of 140 to 160 degrees centigrade for 30-40 minutes, and an unvulcanized rubber material or rubber latex in the unvulcanized rubber sheet for gasket material is vulcanized or the uncrosslinked synthetic resin in the graphite layer is crosslinked to obtain a product. In this case, the metal plate is punched before being applied with adhesive or coated with a compound material, so that the punched-out portions can be reused without waste and the adhesive is applied only on a required portions, thereby reducing the amount of adhesive. Further, the unvulcanized rubber sheet for gasket material of which rubber material or rubber latex is unvulcanized condition is punched, so that the punched-out portions can be reused without waste and the used amount of graphite layer mixture is reduced, thereby remarkably reducing the production cost as a whole. Still further, because the metal plate or the gasket material sheet is separately punched, such a method is applicable to the case when the size of corresponding whole shapes and punch holes is preferably different, thereby improving adaptabilitas for various needs.

When a gasket is produced without integrating with a metal plate, the unvulcanized rubber sheet for gasket material is punched into a predetermined shape and the above-mentioned graphite layer is formed if necessary, and a desirable product can be obtained by executing the above-mentioned heat process. In such a case, waste materials such as the punched-out portions are not produced and the amount of graphite layer mixture is reduced. Further, the produced gasket has superior heat resistance because the rubber compound layer includes a base fiber material comprised of a compressible inorganic fiber except asbestos and a compressible organic fiber. Still further, the rubber compound layer hardly causes drifting and peeling, the torque retentiveness is superior and the characteristic of gasket material made of a compressible material is adequately utilized.

According to the first production method of unvulcanized rubber sheet for gasket material of the present invention, the above-mentioned unvulcanized rubber sheet for gasket material can be easily obtained. In case of the above-mentioned joint sheet, the rubber compound material is formed on the surface of heated roller by heat rolling and is peeled off the heated roller to obtain a product, so that a sheet larger than the surface area of the heat roller cannot be obtained. However, according to the present invention, a sheet of optional size is obtained by varying the size (length) of the metal plate, thereby achieving efficiency of production. Further, a spread layer of rubber compound material is formed on the surface of the metal plate under an unvulcanized condition, so that the spread layer can be made thin comparing to the joint sheet of prior art which is rolled while being heated and vulcanized.

According to the present invention in which at least one side of the metal plate on which the rubber compound material is to be supplied is so surface-treated as to facilitate peeling of the spread layer formed of rubber compound material, the spread layer is easily peeled off the metal plate, thereby contributing to keep product quality.

Further according to the production method of the present invention in which the providing step of a new spread layer of rubber compound material on the other surface of the metal plate is added between the forming step of the spread layer of rubber compound material and the peeling step of the spread layer of rubber compound material out of the metal plate to obtain a spread sheet of rubber compound material, the spread layer is formed on both surfaces of the metal plate before peeling off the spread layer from the metal plate, thereby improving the efficiency of production process.

Still further according to the production method of the present invention in which the thickness control step for the spread layer is added between the forming step of the spread layer of rubber compound material and the peeling step of the spread layer of rubber compound material out of the metal plate to obtain the spread sheet of rubber compound material, the rubber compound material of the spread layer is optionally compressed because it is still unvulcanized, so that a thin sheet can be obtained comparing to the prior method and the applicable scope as a gasket material can be enlarged.

Further according to the second production method of the unvulcanized rubber sheet for gasket material of the present invention, the above-mentioned rubber compound material is supplied into a feeding portion of a pair of rollers which rotate in opposite directions each other at a circumferential speed ratio of 1:1.01 to 1.2 (preferably 1:1.05) so as to be spread, so that a thin spread sheet can be fed out without adhering on the surfaces of both rollers. When the circumferential speed ratio is 1:less than 1.01 to 1, the spread sheet tends to be adhered on the roller of lower circumferential speed. When it is 1:more than 1.2, the spread sheet is apt to be broken. The fed out spread sheet made of unvulcanized rubber compound material is passed through the fitting portion of the pair of gauge control rollers which are arranged at a predetermined space, so that a thin spread sheet of desirable thickness comparing to the prior arts can be surely obtained, thereby enlarging the applicable scope as a gasket material. Still further according to the present invention in which the second gauge control process is added after the above-mentioned gauge control process, a thinner spread sheet can be optionally obtained. Further, according to the present invention in which the above-mentioned surface process is executed on the surface of each roller, the adherability of rubber compound material passing through the fitting portion of the rollers onto the surfaces of the rollers is reduced and the spread sheet can be smoothly fed out.

### BRIEF DESCRIPTION OF THE DRAWINGS

FIG. 1a, FIG. 1b and FIG. 1c show a diagrammatical process of a first production method of an unvulcanized rubber sheet for gasket material according to the present invention.

FIG. 2a and FIG. 2b show diagrammatical latter half process of the same production method.

FIG. 3 is an enlarged view of an essential part of FIG. 1b.

FIG. 4 is the same view as FIG. 3 of a modified embodiment.

FIG. 5 is a diagrammatical view of an apparatus according to a modified embodiment of an apparatus according to the same production method.

FIG. 6 is a diagrammatical view of an apparatus according to a further modified embodiment of the production method of the present invention.

FIG. 7 shows a diagrammatical view of an apparatus according to a second production method of unvulcanized rubber sheet for gasket material according to the present invention.

### DETAILED DESCRIPTION OF THE INVENTION

The preferred embodiments of the present invention are explained referring to the attached drawings.

### EMBODIMENT 1

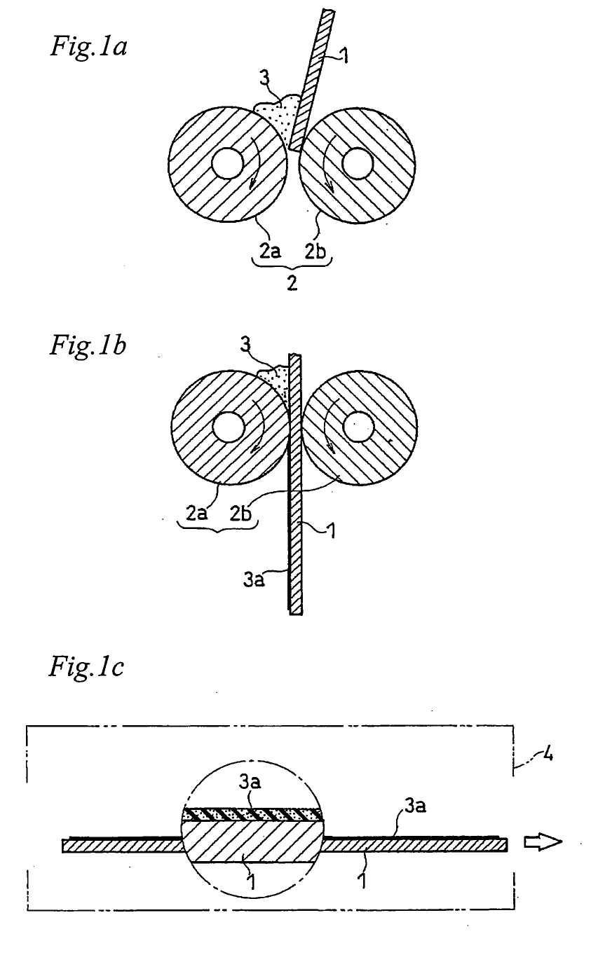

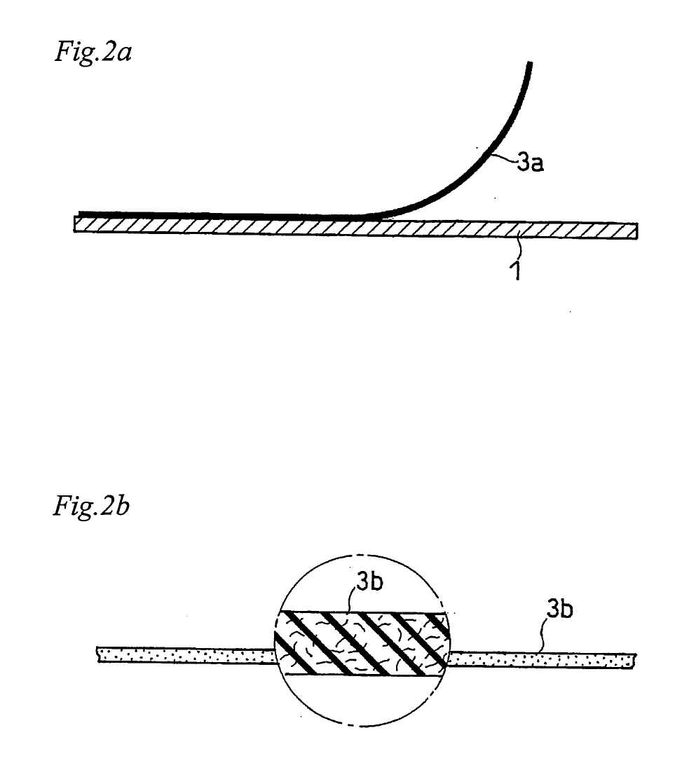

FIG. 1 and FIG. 2 show a diagrammatical process of the apparatus applied to the first production method of the present invention. FIG. 1a shows such process that a metal plate 1 is provided at a feeding portion of a pair of rollers 2 (2a, 2b) and a rubber compound material 3 mentioned above is supplied in a space between one surface of the metal plate 1 and the surface of roller 2a. The metal plate 1 is made of SPCC steel plate, aluminum plate, stainless steel plate, or the like and the surface to which the rubber compound material 3 is supplied is coated (surface-treated) with a low-friction material, for example Teflon (trademark) coating, fluorine coating or diamond like carbon coating (DLC) or the like. The rubber compound material 3 is prepared in advance wherein a base material fiber comprised of a compressible inorganic fiber other than asbestos and a compressible organic fiber, unvulcanized rubber material or rubber latex, rubber agent, an inorganic filler and solvent are knead. The metal plate is surface-treated at least one side of both surfaces on which the rubber compound material is to be supplied, thereby facilitating peeling of the rubber compound material as has been attached thereon.

The compressible inorganic fiber comprising the compound material may be a: glass fiber; ceramic fiber; rock wool; mineral wool; fused quartz fiber; chemical processed high silica fiber; fused alumina silicate fiber; alumina continuous fiber; stabilized zirconia fiber; boron nitride fiber; alkali titanate fiber; whiskers; boron fiber; carbon fiber; metal fiber; or the like. The compressible organic fiber may be an: aromatic polyamide fibers; other polyamide fibers; polyolefine fibers; polyester fibers; polyacrylonitrile fibers; polyvinyl alcohol fibers; polyvinylchloride fibers; polyurea fibers; polyurethane fibers; polyfluorocarbon fibers; phenol fibers; cellulosic fibers; or the like.

The rubber comprising the compound material may be a: nitrile rubber (NBR); styrene-butadiene rubber (SBR); isoprene rubber (IR); chloroprene rubber (CR); butadiene rubber (BR); isobutylene-isoprene rubber (IIR); ethylene propylene rubber (EPM); fluoro rubber (FKM); silicone rubber (Si); chlorosulfonated polyethylene (CSM); ethylene-vinylacetate copolymer (EVA); chlorinated polyethylene (CPE); chloro-isobutene-isoprene rubber (CIIR); epichlorohydrin rubber (ECO); nitrile isoprene rubber (NIR); natural rubber (NR); or the like. Oil extended rubbers that are obtained by adding oil to these rubbers, such that naphthenic process oil is added to SBR, may also be used within the scope of this disclosure.

The rubber agent may be a vulcanizing agent such as sulfur, zinc oxide, magnesium oxide, peroxide, dinitrobenzene, or the like. Further, a vulcanization accelerator such as: thiazole compounds; polyamine compounds; sulfonamide compounds; dithiocarbamate compounds; aldehydeamine compounds; guanidine compounds; thiourea compounds; xanthate compounds; or the like, may be used. The inorganic filler may be a: clay; talc; barium sulfate; sodium bicarbonate; graphite; sulfate; tripoli; wollastonite; or the like. Toluene is preferably used as solvent and is contained in the rubber compound material 3 in the amount of 10 40 percent by weight. Water is used for rubber latex.

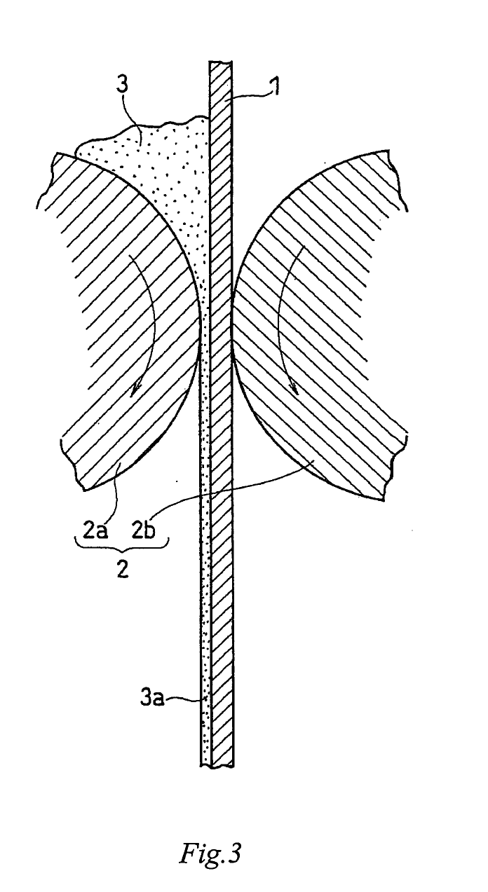

The space between the rollers 2a, 2b is arranged such that the thickness of a spread layer 3a (see FIG. 1b, FIG. 1c) of the rubber compound material 3 formed on the surface of the metal plate 1 becomes 50 200 m. The pair rollers 2a, 2b are rotated in a going with direction as shown in FIG. 1b and FIG. 3 (direction shown with arrows) and the metal plate 1 and the rubber compound material 3 pass through a fitting portion of the rollers 2a, 2b to form the sprad layer 3a of rubber compound material on the surface of the metal plate 1. The circumferential speed of rollers 2a, 2b is set at 1:1.2 1.4. FIG. 1c shows a drying process in which thus formed metal plate 1 passes through (is left in) a dry zone 4 to evaporate the contained solvent. The dry zone 4 is for example a drying chamber provided with a blower or an appropriate drying space for air drying. The metal plate is dried while being carried with a belt conveyer or standing still.

FIG. 2a and FIG. 2b show a process to obtain a spread sheet of rubber compound material (sheet for gasket material) by peeling the spread layer 3a of rubber compound material from the metal plate 1. Such peeling of the spread layer 3a from the metal plate 1 may be continuously executed by means of a scraper while the metal plate 1 is carried on a belt conveyor or manually per a metal plate 1. The spread sheet 3b obtained by peeling does not have a rubber elasticity yet, so that a thin sheet can be obtained by adjusting the space between the rollers 2a, 2b comparing to the joint sheet obtained in the prior art. In addition, the spread sheet 3b is a sheet in which the above-mentioned fiber base material is knead in the above-mentioned unvulcanized rubber material. When such a spread sheet 3b is applied to the above-mentioned gasket, it is punched into an appropriate shape, heated and vulcanized. The punched-out portions can be reused, thereby eliminating waste material.

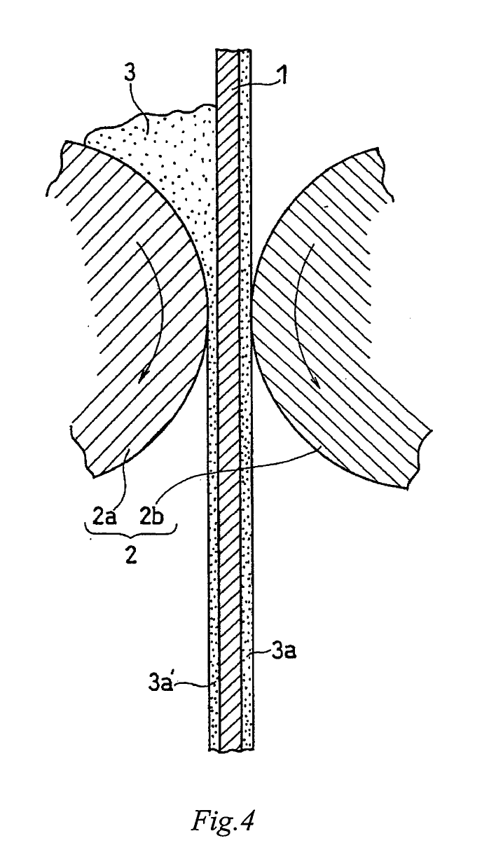

According to the embodiment in FIG. 4, the metal plate 1 provided with the spread layer 3a of rubber compound material on one surface is reversed and is disposed at the feeding portion of the rollers 2a, 2b again before the drying process. Further, the compound material 3 is supplied between the other surface of the metal plate 1 and the roller 2a and the metal plate 1 having the spread layer 3a of the rubber compound material and the newly supplied compound material 3 pass through the fitting portion of the rollers 2a, 2b to form a new spread layer 3a′ of rubber compound material on the other surface of the metal plate 1. The spread layers 3a, 3a′ of rubber compound material are formed on both surfaces of the metal plate 1 before the drying process, so that the drying time is practically reduced to improve productive efficiency.

It is not shown in the figure, however, a gauge control process may be added between the drying process and the peeling process of the spread layer 3a (3a of rubber compound material from the metal plate 1 to obtain the spread sheet 3b of rubber compound material, and the metal plate 1 formed with the spread layer 3a (3a′) of rubber compound material passes through a fitting portion of a pair of gauge control rollers (the rollers 2a, 2b may be also used) to compress the spread layer 3a (3a of rubber compound material to control the thickness. The spread layer 3a (3a′) does not have a rubber elasticity yet, so that a thinner spread sheet 3b may be optionally obtained by adding such a gauge control process.

### EMBODIMENT 2

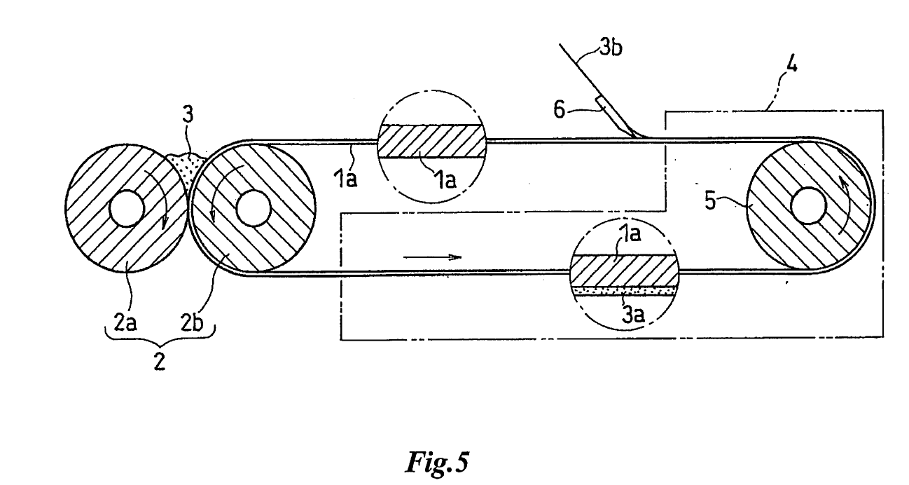

FIG. 5 shows a modified embodiment of the first production method. An endless band steel 1a as a metal plate is wound and suspended around the roller 2b of the pair of rollers 2a, 2b and other roller 5 to form a belt conveyor; the rubber compound material 3 supplied into a feeding portion of the rollers 2a, 2b is spread while rotating the pair of rollers 2a, 2b, the roller 5, and the band steel 1a in the direction shown with arrows, then the spread layer 3a of rubber compound material is continuously formed on the surface of the band steel 1a. The spread layer 3a of rubber compound material thus formed on the band steel 1a is carried with the band steel 1a while evaporating the contained solvent in the drying zone 4, and is sequentially peeled off as a spread sheet 3b of rubber compound material by means of a scraper 6 provided so as to slide the surface of the band steel 1a. The band steel 1a on which spread sheet 3b is peeled off is introduced into the feeding portion of the rollers 2a, 2b, the rubber compound material 3 is supplied, the rubber material is spread, and the spread sheet 3b is peeled off, thus repeating the procedures. Accordingly, when the sheet for gasket material is continuously produced as mentioned above, the system can be made compact and the productive efficiency is improved.

### EMBODIMENT 3

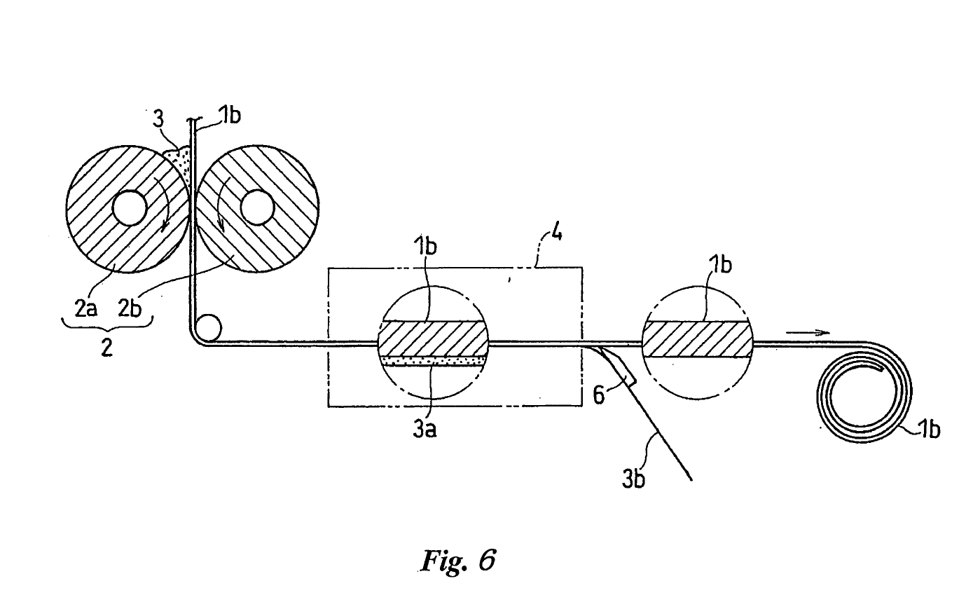

FIG. 6 shows other embodiment of the first production method. Long band steel 1b as a metal plate is introduced into the fitting portion of the pair of rollers 2a, 2b, the rubber compound material 3 is supplied as mentioned above, the spread layer 3a of rubber compound material is formed on the surface of the band steel 1b, the solvent is evaporated in the drying zone 4, and the spread sheet 3b of rubber compound material is sequentially peeled off by means of the scraper 6 attached so as to slide on the surface of the band steel 1b. The band steel 1b on which spread sheet 3b is peeled off is sequentially rolled up. A well-known take-up means is used for rolling up the band steel 1b. The apparatus for this production method is compact and improves the productive efficiency like the embodiment 2. Other structure is the same as that of embodiment 2, so the same reference numerals are allotted to the common members and their explanations are omitted here.

### EMBODIMENT 4

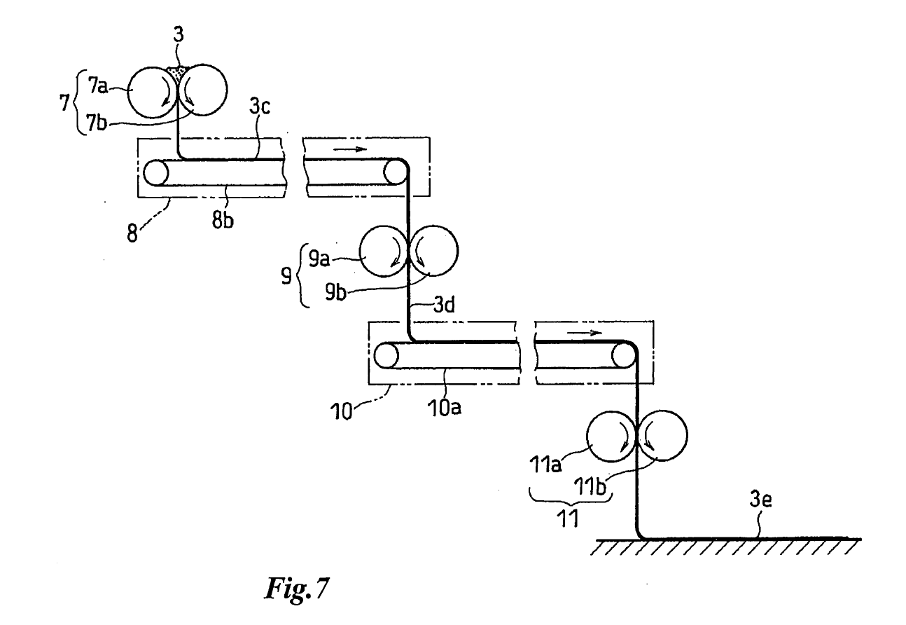

FIG. 7 shows a production process of unvulcanized rubber sheet for gasket material using the apparatus for the second production method of the present invention. The rubber compound material 3 is supplied into the feeding portion of pair of rough rollers 7 (7a, 7b) which rotate in a going-with direction as mentioned above and of which circumferential speed ratio is set at 1:1.01 1.2 (preferable 1:1.05), the rubber compound material 3 passes through the fitting portion of the rollers 7a, 7b according to the rotation of rollers 7a, 7b, and a spread sheet 3c of rubber compound material (thickness 300 500 m) is fed out. The spread sheets 3c thus formed continuously drop on a belt conveyor 8a constituting a drying zone 8, the contained solvent is evaporated on the belt conveyor 8a, then the sheet 3c passes through the fitting portion of the pair of gauge control rollers 9 (9a, 9b) arranged with a predetermined space, and a spread sheet 3d (sheet for gasket material) of rubber compound material with a desired thickness is obtained.

In the figure, the second drying zone 10 and the second gauge control rollers 11 (11a, 11b) are sequentially provided next to the gauge control roller 9. The spread sheet 3d is further compressed to obtain a spread sheet 3e with 50 200 m thickness. The rubber material or rubber latex of the spread sheet 3c fed out of the rollers 7a, 7b is unvulcanized, so that optional gauge control can be executed with the gauge control rollers 9a, 9b and the second gauge control rollers 11a, 11bwhich are provided at downstream, thereby obtaining a thin spread sheet 3e which cannot be obtained by the prior joint sheet. The spread sheet 3e is rolled up by a drum (not shown) as a product sheet for gasket material.

The surface of the rollers 7a, 7b are coated (surface-treated) with a low-friction material as mentioned above. The circumferential speed ratio of the rollers 7a, 7b is set as mentioned above. Thus, the rubber compound material 3 is prevented from adhering on the rollers 7a, 7b. This embodiment of production method is characterized in that the metal plate 1 is not required as mentioned in the above embodiments and a preferable embodiment is selectively used.

The sheet for gasket material obtained according to the production method of the present invention is punched-out as mentioned above, or is integrated with a metal plate, and further is graphite processed to be heated or vulcanized. The resultant product is widely used for a cylinder head gasket of vehicle engine, several kinds of gasket for internal combustion engine, and other portions to be sealed. The sheet of the present invention is so thin comparing with the prior products that its applicable utilization is enlarged. Further, the production process in the embodiments mentioned above includes a drying process, however, a drying process may not be required depending on the amount of solvent contained in the rubber compound material and the temperature of rollers.

Although only preferable embodiments of the present invention have been disclosed and described, it is apparent that other embodiments and modification of the invention are possible.

1. An unvulcanized rubber sheet for gasket material composed of a sheet like rubber compound material, wherein said rubber compound material comprises a base fiber material comprised of a compressible inorganic fiber except asbestos and a compressible organic fiber, an unvulcanized rubber material or a rubber latex, rubber agent and inorganic filler.

2. A method for manufacturing an unvulcanized rubber sheet for gasket material, comprising the steps of:
disposing a metal plate at a feeding portion of a pair of rollers, each of which rotates opposite direction each other and supplying a rubber compound material into a space between one side of said metal plate and one side of said rollers;
passing said metal plate together with said rubber compound material as supplied through said rollers by rotating said rollers to form a spread layer of rubber compound material on said metal plate; and
peeling said spread layer thus formed out of said metal plate, thereby forming a continuous spread sheet of rubber compound material, wherein;
said rubber compound material includes a base fiber comprised of a compressible inorganic fiber except asbestos and a compressible organic fiber, an unvulcanized rubber material or a rubber latex, rubber agent and inorganic filler

3. The method for manufacturing an unvulcanized rubber sheet for gasket material as set forth in claim 2, wherein at least one side of said metal plate on which said rubber compound material is to be supplied is so surface-treated as to facilitate peeling of said spread layer formed of said rubber compound material.

4. The method for manufacturing an unvulcanized rubber sheet for gasket material as set forth in claim 2, wherein said method further comprises the steps of:
disposing again said metal plate as have been formed with said spread layer of rubber compound material on one side at said feeding portion of said pair of rollers and further supplying said rubber compound material into a space between the other side of said metal plate and one side of said rollers; and
passing said metal plate as have been formed with said spread layer of rubber compound material together with rubbercompound material as further supplied through said rollers, thereby further forming a spread layer of rubber compound material on the other surface of said metal plate.

5. The method for manufacturing an unvulcanized rubber sheet for gasket material as set forth in claim 2, wherein a pair of gauge control rollers for controlling the thickness is further provided and wherein said method further comprises the step of:
passing said metal plate as have been formed with said spread layer of rubber compound material on its one side surface or both side surfaces into said pair of gauge control rollers, thereby compressing said spread layer of rubber compound material to control its thickness.

6. A method for manufacturing an unvulcanized rubber sheet for gasket material, comprising following steps:
supplying a rubber compound material step in which a rubber compound material is supplied into a feeding portion of a pair of rollers, each of which rotates opposite direction each other at a circumferential speed ratio of 1:1.01-1.2;
forming a continuous spread sheet step in which said rubber compound material is passed through a fitting portion of said rollers by rotating said rollers to form a continuous spread sheet of rubber compound material; and
thickness controlling step in which said spread sheet of rubber compound material thus formed is passed through a fitting portion of pair of gauge control rollers which are adjusted at a predetermined space, thereby controlling the thickness of said spread sheet of rubber compound material at a desired thickness, wherein
said rubber compound material includes a base fiber comprised of a compressible inorganic fiber other than asbestos and a compressible organic fiber, an unvulcanized rubber material or a rubber latex, rubber agent and inorganic filler.

7. The method for manufacturing an unvulcanized rubber sheet for gasket material as set forth in claim 6, wherein a second pair of gauge control rollers are further provided at downstream of said pair of gauge control rollers and wherein further thickness controlling step by said second pair of gauge control rollers is performed after said thickness controlling step.

8. The method for manufacturing an unvulcanized rubber sheet for gasket material as set forth in claim 6, wherein each surface of said pair of rollers is so surface-treated as to facilitate peeling of said spread layer formed of said rubber compound material.

9. The method for manufacturing an unvulcanized rubber sheet for gasket material as set forth in claim 3, wherein said method further comprises the steps of:
disposing again said metal plate as have been formed with said spread layer of rubber compound material on one side at said feeding portion of said pair of rollers and further supplying said rubber compound material into a space between the other side of said metal plate and one side of said rollers; and
passing said metal plate as have been formed with said spread layer of rubber compound material togetherwith rubber compound material as further supplied through said rollers, thereby further forming a spread layer of rubber compound material on the other surface of said metal plate.

10. The method for manufacturing an unvulcanized rubber sheet for gasket material as set forth in claim 3, wherein a pair of gauge control rollers for controlling the thickness is further provided and wherein said method further comprises the step of:
passing said metal plate as have been formed with said spread layer of rubber compound material on its one side surface or both side surfaces into said pair of gauge control rollers, thereby compressing said spread layer of rubber compound material to control its thickness.

11. The method for manufacturing an unvulcanized rubber sheet for gasket material as set forth in claim 7, wherein each surface of said pair of rollers is so surface-treated as to facilitate peeling of said spread layer formed of said rubber compound material.

12. The method for manufacturing an unvulcanized rubber sheet for gasket material as set forth in claim 4, wherein a pair of gauge control rollers for controlling the thickness is further provided and wherein said method further comprises the step of:
passing said metal plate as have been formed with said spread layer of rubber compound material on its one side surface or both side surfaces into said pair of gauge control rollers, thereby compressing said spread layer of rubber compound material to control its thickness.
